(19) United States
(12) Patent Application Publication
(10) Pub. No.: US 2014/0114785 A1
(43) Pub. Date: Apr. 24, 2014

(54) SYSTEM, METHOD AND APPARATUS THAT ENABLES A NEW ECONOMIC ARCHITECTURE FOR THE EXCHANGE OF VALUE

(71) Applicant: Recipco Holdings Ltd., Vancouver (CA)

(72) Inventors: James Fierro, Vancouver (CA); Barry Davenport, Clearview (CA); Rikki Chow, Toronto (CA); Peter Howe, Niagara-on-the-lake (CA)

(73) Assignee: Recipco Holdings Ltd., Vancouver (CA)

(21) Appl. No.: 14/056,104

(22) Filed: Oct. 17, 2013

Related U.S. Application Data
(60) Provisional application No. 61/715,912, filed on Oct. 19, 2012.

(51) Int. Cl. G06Q 20/06

(52) U.S. Cl. CPC G06Q 20/06
USPC 705/26.1

(57) ABSTRACT

An electronic capacity exchange system comprises one or more computing devices in communication with one another via at least one of a wired and wireless network. In one aspect, the system is configured to receive capacity orders for product and/or service capacity that include an associated order value in terms of non-monetary universal trading units (UTU's). In addition, the system receives at least electronic indication of interests, at least one of which corresponds to at least one capacity order. The indication of interest is compared to its corresponding capacity order and if there is a match, a capacity may be consummated and executed. Upon execution of the capacity transaction, a quantity of UTU's is credited and/or debited from electronic UTU accounts pertaining to one or both parties to the capacity transaction.

### TECHNICAL FIELD

The present disclosure relates generally to online and offline systems, methods and apparatus for exchanging available and excess capacity in the form of goods and services, and in particular, to trading systems, methods and apparatus adapted for the discovery, negotiation, facilitation and exchange of capacity between entities utilizing a novel, non-monetary universal trading unit.

### BACKGROUND

There are daily reminders of the limitations of sovereign economic systems, namely, those relating to private financial monetary institutions and those relating to sovereign governments that, whether alone or in collaboration with others, have to ensure liquidity and the optimal functioning of supply and demand within those economies and across economies internationally. Limitations of existing economic systems include, for example, the conflict that inevitably exists between monetary policy and bank reform; the inefficiencies of operating and/or doing business in multiple jurisdictions that utilize different monetary systems and currencies; and the increasing scarcity of cash and credit. As an illustrative example, it is estimated that billions of dollars of capacity goes unsold and unused every day. Interestingly, this underutilization of capacity is not due to a shortage of need or desire for such capacity. Instead, much of this capacity goes under-utilized or unused because the money needed to obtain such capacity is just not available.

As a result of the limitations described above (as well as others that may exist) of existing economic systems, it is evident that money alone (regardless of the type of currency) is no longer sufficient as the only accepted and trusted store of value and unit of exchange. Indeed, there is a need to have an alternate store of value or unit of exchange that is readily available and addresses the many limitations associated with conventional economic systems, and in particular, with respect to money.

In connection with the foregoing, it is desirable to have a system, method and apparatus which allows corporations, governments, not-for-profit organizations and any other type of organization, as well as individuals and entities, to have easy and efficient counterparty discovery, communications and negotiations related to the trade, execution and settlement of transactions using a novel, non-monetary unit of exchange.

It is also desirable to have a non-monetary unit of exchange that is optionally tied to the amount of goods and/or services in circulation such that inflation is controlled.

It is also desirable to have a system, method and apparatus configured to provide alternative and complementary types and sources of trade credit and financing, as well as alternative channels for the distribution of goods and/or services, thereby drawing new customers and improving pricing.

### SUMMARY

The present disclosure relates generally to systems, methods and apparatus for facilitating non-monetary capacity transactions. To that end, the present disclosure describes systems, methods and apparatus for receiving, at an electronic capacity exchange, one or more capacity orders, each including a product and/or service description and an associated order value in terms of non-monetary universal trading units (UTU's). Entities desiring to procure or sell capacity may submit an electronic indication of interest to the electronic capacity exchange. The electronic capacity exchange system may then compare certain data included in the indication of interest (“interest data”) with corresponding data included in the at least one capacity order (“order data”) to determine if there is a match. If it is determined that the interest data and order data match, a capacity transaction may be consummated and executed via the electronic capacity exchange system. Upon executing the capacity transaction, a quantity of UTU's corresponding to the capacity transaction may be issued and/or debited from the electronic UTU accounts of the parties to the capacity transaction.

### BRIEF DESCRIPTION OF THE DRAWINGS

The foregoing summary and the following detailed description are better understood when read in conjunction with the appended drawings. Exemplary embodiments are shown in the drawings, however, it is understood that the embodiments are not limited to the specific methods and instrumentalities depicted herein. In the drawings:

FIG. 1. is a block diagram illustrating an exemplary system in accordance with the present disclosure;

FIG. 2. is a flow diagram illustrating an exemplary flow diagram illustrating the issuance of a non-monetary unit of exchange to a member entity via a credit facility agreement in accordance with the present disclosure;

FIG. 3. is a flow diagram illustrating exemplary approaches for valuing a non-monetary unit of exchange in accordance with the present disclosure;

FIG. 4. is a block diagram illustrating an exemplary life cycle of a capacity transaction in accordance with the present disclosure;

FIG. 5. is a flow diagram illustrating an exemplary method of qualifying an entity for membership to a capacity exchange in accordance with the present disclosure;

FIG. 6. is a flow diagram illustrating an exemplary method by which capacity orders may be entered into an order catalogue within a capacity exchange system in accordance with the present disclosure;

FIG. 7. is a diagram illustrating exemplary system components of a capacity exchange configured for entering and receiving capacity orders in accordance with the present disclosure;

FIG. 8. is a flow diagram illustrating an exemplary data flow between member systems and a central resource planning hub in accordance with the present disclosure;

FIG. 9. is a flow diagram illustrating exemplary methods and systems for searching and matching capacity orders to initiate capacity transactions in accordance with the present disclosure;

FIG. 10. is a flow diagram illustrating exemplary methods and systems for consummating capacity transactions in accordance with the present disclosure; and

FIG. 11. is a flow diagram illustrating exemplary methods of accounting a non-monetary unit of exchange in accordance with the present disclosure.

### DETAILED DESCRIPTION

The present disclosure provides a systematic means of linking capacity with needs in a manner that obviates the limitations of conventional sovereign currency systems. As a result, the present disclosure is able to improve economic conditions by improving the utilization of excess and available capacity, while at the same time unlocking new sources of capital and revenue for all types of entities, from small businesses to large corporations. This improved utilization (of capacity) may take the form of an increased utilization rate (e.g., realizing additional sales from previously under-utilized or excess capacity), increased margins, for example. Other features and potential advantages of the present disclosure may include (without limitation) providing an additional channel for producers to sell their capacity, providing means (e.g., by unlocking new sources of capital and revenue) that make it possible for financially-challenged producers to procure needed or desired products and/or services, providing a marketplace which is distinct from cash markets in which margin differentials between a buyer and seller can be shared without compromising pricing, providing a trusted and reliable medium of exchange based on the mutual commitment of credible providers of capacity, and others. To achieve these and other features and advantages, the present disclosure provides a novel non-monetary trading system, apparatus and methodology that is appropriately structured for exchanging capacity in view of the deficiencies (and scarcity) of actual money. Collectively, the systems, apparatus, and methodologies described herein provide a mechanism and infrastructure by which entities are able to effectively and efficiently manage and utilize available capacity. In addition, the present disclosure provides novel means for procuring products and/or services using special purpose (non-monetary) trading units, rather than conventional cash or currency. As such, the systems, apparatus, and methodologies described herein enable entities to efficiently manage their respective inventories, excess capacity and certain assets as an alternative channel of trade and distribution. As further described herein, member entities may receive special purpose trading units representing a value of their respective (existing and/or future) inventory, capacity and/or certain assets, which may then be used to procure products and/or services of other member entities, thus conserving cash and traditional financing facilities such as lines of credit. In addition, utilizing the special purpose trading units described herein (rather than cash) will enable entities to protect the list prices of their product and/or service catalogue in the cash market. This protection is provided, at least in part, by the anonymous nature of systems and methodologies described herein. This anonymity protects entities and allows them to maintain their intended pricing in the cash market.

The present disclosure has identified a new, accessible market that is based on the excess capacity and needs of certain entities. Excess capacity may include, for example, unsold or unused products and/or services, or excess products and/or services (beyond existing demand) that organizations have purposely built up to accommodate anticipated future demand or growth. Notably, this new, accessible market extends well beyond the United States and into developing countries worldwide. For example, some estimates suggest that there are over twenty-five (25) million formal small and medium enterprises (“SMEs”) worldwide that have the potential to create the equivalent of US$900B of additional addressable market that is based on their excess capacity.

In one aspect, the present disclosure provides to a smart network of member entities (e.g., corporations, government agencies or institutions, etc.), each producing capacity that may be of interest for other member entities to acquire, and where member entities may optimize their financial performance using data-flows within the network to drive inventory management, procurement planning, capacity planning and financial management systems.

In order to take advantage of the new capacity market referenced above, the present disclosure provides a new economic architecture that defines a new economic environment that is distinct from conventional currency-based economies and features alternatives to traditional methods of financing and sourcing working capital. This new economic environment may be structured using a broad but shallow model, such as a market featuring a wide variety of products, a narrow but more in-depth model that includes limited product types but many varieties therein, which may be better suited for more specialized markets and where detailed specifications may be needed to identify product matches, or any model in between.

Further, the new economic architecture described herein may be based on a new, special purpose trading unit (hereafter a “Universal Trading Unit” or “UTU”) that serves as a vehicle of exchange for transactions involving capacity. Unlike sovereign currency, which is issued by governments and backed by their authority of taxation, the UTU is a vehicle of exchange issued by a special purpose entity (or a conglomerate of entities) that may be backed (i.e., secured) by actual product and/or service capacity. As such, the UTU provides a legitimate, credible and liquid alternative to cash (or any other sovereign liquidity instruments used around the world).

The present disclosure also provides systems, methods and apparatus for creating, issuing and/or managing UTU's, and/or for facilitating transactions for which UTU's serve as the vehicle of exchange. An exemplary system may comprise, for example, one or more computer devices, each comprising a processor configured to execute computer-readable instructions, configured to communicate with each other via a wired and/or wireless network. Such computer devices may include, without limitation, computer terminals, servers, mobile communication devices, desktop computers, smart phones, PDAs (personal data assistants), mobile computers, tablet computers, or any other such device configured to perform the functions described herein.

In one embodiment, a capacity exchange system according to the present disclosure includes a UTU system configured to create, issue and manage UTU's, and an exchange system configured to facilitate counterparty discovery, communications and the execution and settlement of transactions involving UTU's. The UTU system and the exchange system may comprise one single, co-located system, or they may comprise multiple independent sub-systems, at various locations, coupled and configured to operate together.

The UTU system may optionally be governed by a special committee that is tasked with the creation of the basic credit risk management framework for issuing UTU's. To that end, the UTU system may be configured to determine whether a particular entity may qualify for membership to the UTU system. This may include, for example, determining whether the particular entity has an existing debt rating which would entitle that entity to receive an advance in UTU's and/or determining whether the particular entity is otherwise in a position to guarantee the amount of UTU's advanced thereto. As noted above, UTU's represent a vehicle of exchange that is backed by actual products and/or services of member entities. As such, any amount of UTU's granted to a member entity will reflect that entity's available (or expected) products and/or services. By correlating the issuance of UTU's to a member entity's actual capacity, the UTU system is able to provide a control mechanism that protects UTU values, controls UTU inflation, and instills member confidence and trust in UTU's and the UTU system.

Optionally, UTU's may be issued based on a member entity's credit rating. For example, member entities that have an investment grade credit rating or that have undergone credit enhancing methods, may be issued UTU's in accordance with their historical or anticipated capacity.

The UTU system may further be configured to maintain and track data relating outstanding UTU's that have been issued, as well as data relating to their repayment. As part of its risk mitigation strategies, the special committee may optionally utilize the UTU system to set up a contingency UTU reserve. Alternatively, the special committee may optionally purchase risk containment instruments, such as insurance against non-performance by member entities.

The exchange system may be configured to operate with the UTU system to facilitate use of UTU's as currency for the procurement, disposal and/or exchange of (e.g., trading) products and/or services that include (without limitation) energy, media, telecommunications, paper, printing, transportation, travel, etc. In one embodiment, the exchange system may be configured as a global marketplace that is constituted by its member entities which may include, without limitation, corporations, enterprises, government agencies, institutions, small businesses, individuals, non-governmental organizations and/or any other type of organization or entity. As such, the global marketplace described herein may provide a coherent link among the production, inventory, procurement, capacity planning and finance modules of the member entities. In one embodiment, this link may include an actual data link (further described below) that connects enterprise resource planning (“ERP”) systems of member entities such that data from one entity's inventory management system, for example, could be electronically matched with data from a procurement system of another entity. An additional time dimension may also be implemented to enable information to be more precisely used for capacity planning, for example.

As noted above, the exchange system facilitates discovery of trading opportunities, and enables member entities to utilize UTU's (rather than cash) to “buy and sell” products and services from the available capacities of other entities. As such, the exchange system provides a platform by which member entities may procure products and services in exchange for value that is secured by their own respective capacity (in the form of UTU's). The exchange system may also be configured with bookkeeping functions to record UTU issuance, draw-downs, redemptions, credit facilities denominated in UTU's (discussed below), and so on.

In addition, the exchange system (in connection with the UTU system) may be configured to provide a mechanism for different types of credit creation and exchange between entities, including (without limitation) business-to-business (B2B) lending, business-to-government (B2G) lending; government-to-government (G2G) lending; peer-to-peer (P2P) lending; factoring and taking orders; insurance, credit insurance enhancement, and performance insurance; and guarantees and institutional backing by credit worthy entities. As such, UTU's may be lent instead of money, which may reduce risks associated with traditional lending.

The exchange system described herein may also be configured to facilitate (e.g., list, negotiate, execute, settle, etc.) bilateral trades between two member entities, multi-lateral trades among multiple member entities, and/or unilateral trades whereby an entity may simply exchange available capacity to the exchange system for UTU value which may be utilized at a later date to procure products and/or services. This flexibility solves the problem of having to find counter parties who each want the other party's products or services in order to conclude a transaction.

In addition, the exchange system may be configured to facilitate the actual usage and/or consumption of traded products and/or services, with the added capability of facilitating the actual settlement of transactions for the products and services. To that end, the exchange system may be configured to facilitate (directly or via a member entity or a third party) services such as trade financing, escrow, warehousing, payments and insurance services.

In order to provide counterparty discovery, the exchange system may further comprise an optional matching engine configured available capacity with wanted or needed products and/or services.

Access to the UTU and/or exchange systems may be provided via a programmatic client computer over the Internet as well as remotely via a web client over the Internet and a secure connection.

In another aspect, the present disclosure provides business intelligence, which includes new approaches for enhancing entity value by providing new tools for optimizing the management of inventory, production, capacity planning, procurement, capital projects, strategic sourcing and pricing strategy. Development of such business intelligence may include, for example, development of a “hub and spoke” model that may be implemented in several phases. In one embodiment, the ‘hub’ of this model may comprise an order catalogue (further defined below), and the spokes may comprise one or more entity enterprise resource planning (ERP) systems.

Implementation of this hub and spoke model may include a first phase, in which the hub (e.g., an order catalogue) may be implemented to support initial trading activity, which may include (without limitation) trade approval and processing, clearance and maintenance of electronic UTU records, and a basic data repository of orders to support a trade discovery process that may be automated and/or involve human interaction. Such orders may correspond to available capacity (e.g., offers) and to desired procurement (e.g., bids) such that data collection, matching and trade discovery is made possible by interfacing with the inventory management and/or procurement management systems (e.g., ERP's) of entities.

A second phase of implementation may include further development of the “hub” through the transformation of the “basic data repository of orders” into a true order catalogue with industry-specific product details. Completion of this phase may enable members to conduct trade discovery. The availability of detailed product details in the order catalogue may also reduce the time required for identifying suitable matches. In addition, as orders from the order catalogue are matched and executed as capacity transactions, information such as UTU price data for specific order catalogue items may be recorded and utilized to determine and/or track the purchasing power of a UTU. This price data may also be utilized to derive cross-rates between different catalogue items (e.g., the price of hotel rooms in terms of telecommunication services). Such pricing and/or cross-rate information may itself be offered for sale or procurement as a catalogue item.

A third phase may include adding the “spokes” (e.g., integration and interfacing entity ERP systems with the order catalogue) to the hub (e.g., order catalogue) model, thereby adding inventory management, procurement planning, capacity planning, finance modules and other ERP components to the model. For example, procurement requirements drawn from purchasing modules of certain entities may be made available to inventory management modules of other entities. The combined information may in turn feed each entity's capacity planning system, thereby automating and systemizing the optimization of capacity utilization. As another example, linking order and transaction data (from the order catalogue) to finance modules of entity ERP systems may enable margin optimization and provide decision support for determining optimal pricing by providing functionality to enable data mining to determine product demand, for example. Margin optimization refers generally to an ability to monetize available capacity so as to increase actual operating margin and, in economic terms, an ability to diminish the marginal cost of production (and therefore the average cost of all production). Thus, in sum, margin optimization refers to maximizing operating and/or production margins.

Optionally, the data and information exchanged between entity systems may be done so according to confidentiality requirements of each entity, so that only the data that each entity is willing to share may be made available to other entities. In addition, bids and offers may be made anonymously and the identity of entities may only be made known when there is an agreement to trade following a match (or at least a qualified interest to trade), for example.

In addition to the foregoing, the hub-and-spoke model may be configured to identify potential capacity opportunities in terms of margin to a capacity owner; anonymously match capacity between entities; calculate and compare pricing between cash markets and a UTU market to identify which market (for particular capacity) is more profitable, and others.

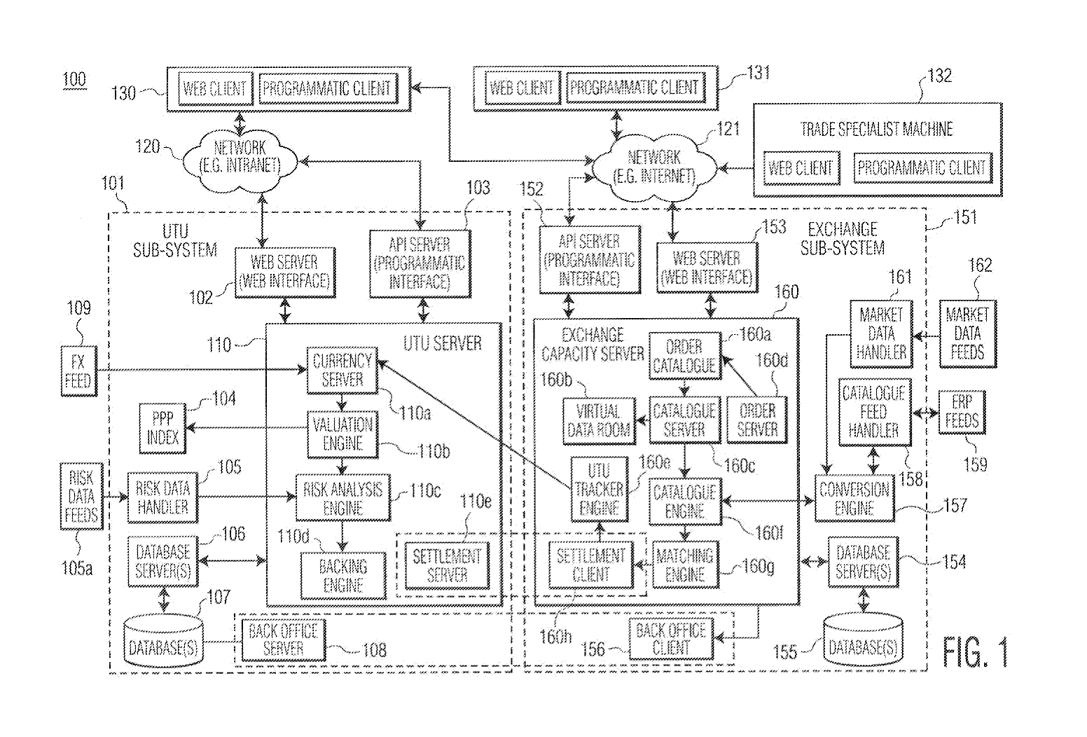

Turning now to FIG. 1, an exemplary system 100 in accordance with the present disclosure is shown. The exemplary system 100 includes a UTU sub-system 101 and an exchange sub-system 151. In this example, the UTU sub-system 101 is configured for issuing, managing, assessing and valuing UTU's, the exchange sub-system 151 is configured for facilitating transactions involving capacity (e.g., products and/or services that are available or assured of being available in exchange for UTU's), and the two sub-systems are collectively configured to settle transactions. It should be understood, however, that either sub-system may be configured to perform one or more functions of the other. It should also be understood that the system 100 may be reconfigured to include more or fewer sub-systems.

The UTU sub-system 101 includes a UTU server 110, which may include one or more computing devices. For purposes of this disclosure, a computing device may include (without limitation) any number of local servers, remote servers, mobile communication devices, desktop computers, smart phones, PDAs (personal data assistants), mobile computers, tablet computers, or any other computing device comprising a processor configured for executing computer-readable instructions.

The UTU server 110 may optionally comprise a currency server 110a, a valuation engine 110b, a risk analysis engine 110c, a backing engine 110d, and a settlement server 1100e.

Users desiring to receive UTU's for engaging in “capacity transactions” (e.g., transactions by which a user procures available products and/or services of another in exchange for UTU's) may access the UTU server 110 via a user computing device 130 over a wired or wireless network 120 (e.g., the Internet) via a web server 102 and/or an application programmatic interface (API) server 103. In one embodiment, users may be required to undergo a qualification process before access to the UTU server 110 (or the entire system 100) is granted. This qualification process may include, for example, determining the creditworthiness of the user.

Prior to issuing UTU's (or UTU credit) to a user, the UTU server 110 may be configured to determine a value (in terms of UTU's) of the user's capacity (e.g., products and/or services) via the valuation engine 110b, which may be configured to execute a valuation algorithm. This valuation algorithm may utilize currency data from the currency server 110a (which may include foreign exchange rate data from FX feed 109) and purchasing power parity (or “PPP”) index data 104 which may be based on cross-rate valuation data collected from previously executed capacity transactions. This cross-rate valuation data may come from the UTU tracker engine 160e (discussed below) which feeds transaction data into the currency server 110a.

In addition, risk data (from risk data feeds 105a) may be provided to the risk analysis engine 110c via one or more risk data handlers 105. This risk data may be utilized, for example, to determine the creditworthiness of the user and/or to determine or adjust the number of UTU's issued to the user.

The allocation and variation of the liability of backing may be determined and captured by the backing engine 110d. The backing engine 110d may also be configured to determine a method of economic backing (for issued UTU's) that is most appropriate for specific user entities. To do this, the backing engine 110d may be configured to obtain risk analysis data from the risk analysis engine 110c and determine appropriate backing method(s) based on the risk analysis data. This risk analysis data may include (without limitation), for example, entity solvency data, credit rating data (which may be obtained or directly determined by the risk analysis engine 110c), entity production capacity (and/or ability to make services available), historical delivery information, sales history, economic information, creditor information, debt information, geo-political information, entity field of technology data, entity infrastructure data, economic information, etc.

In one embodiment, an appropriate method of backing may be based on the full faith and credit of an entity (e.g., where the entity is determined to have a superior credit rating), whereas in another embodiment, an appropriate method of backing may require actual availability of capacity e.g., where the entity is determined to have an inferior credit rating). In yet another embodiment, the backing engine 110d may determine that an appropriate method of economic backing be based on balance sheet liability in the form of a call on an entity's balance sheet, namely, debt as a current liability. Still further, if an entity is determined to have a medium credit rating, the backing engine 110d may determine that an appropriate method of economic backing includes credit enhancement through the use of insurance. In other words, the entity may be required to ‘enhance’ his credit rating through the use of insurance in order to bring the credit rating of the entity to that of the insurance provider, thereby qualifying the entity for UTU credit (backed by the full faith and credit of the entity and insurance provider).

In addition to the optional forms of economic backing of the UTU's discussed above, other possible forms of economic backing include (without limitation): corporate credit; loan structures; structured finance; securitization; performance guarantee insurance; collateralization; commodities; asset baskets; derivatives; third party credit; bills of exchange; letter of credit; factoring; and other engineered financial products and asset classes. Providing such diversity in the available methods of economic backing enables different entities to back the UTU in manner that is appropriate and suitable for each particular entity (e.g., in the context of each entity's credit risk and/or industry sector), while at the same time instilling confidence in the value of the UTU to other entities.

Data coming through the UTU server 110 may communicate with one or more database servers 106 that in turn may feed the data to one or more databases 107 within the UTU sub-system 101. This data may then be accessed by back office server(s) 108 to validate this data.

The settlement server 110e may, in conjunction with the settlement client 160h, be configured to settlement transactions executed via the exchange sub-system 151.

Turning now to the exchange sub-system 151, a capacity exchange server 160 configured for facilitating the execution of, confirming and/or settling capacity transactions may be included therein. This may include, for example, recording UTU exchanges upon execution of capacity transactions. Optionally, users (e.g., both traders and counterparties) may be required to agree in advance (e.g., as part of an exchange membership agreement, trade membership rules and/or codes of conduct, for example) that the capacity exchange server 160 will be utilized to confirm trades, and that delivery (e.g., at a future date) may be the responsibility of the particular trader/counterparty.

In this exemplary embodiment, the capacity exchange server 160 may be centrally located with respect to traders and counterparties, and independent from said traders and the counterparties. As such, users may access the capacity exchange server 160 via one or more user computing devices 130, 131, 132, which may include (without limitation) UTU sub-system “member” devices 130, exchange sub-system “member” devices 131, trade specialist devices 132 and/or any other computer device, over a wired or wireless network 121 (e.g., the Internet) via a web server 153 and/or an application programmatic interface (API) server 152.

The capacity exchange server 160 may be comprised of one or more computer devices, including (without limitation) local servers, remote servers, mobile communication devices, desktop computers, smart phones, PDAs (personal data assistants), mobile computers, tablet computers, or any other computing device comprising a processor configured for executing computer-readable instructions. Included within the capacity exchange server 160 may be one or more of the following: order catalogue 160a, virtual data room 160b, catalogue server 160c, order server 160d, catalogue engine 160f, UTU tracker engine 160e, matching engine 160g and a settlement client 160h.

The order server 160d may include one or more order catalogues 160a which include capacity orders (i.e., orders reflecting available and/or desired goods and/or services in terms of UTU's) available for transacting. The order server 160d may receive capacity order data from the catalog server 160c, which may itself include one or more catalogue engines 160f, as well as from other internal and external sources. In one embodiment, the catalogue engine(s) 160f may be configured to receive capacity data (in terms of UTU's) from a conversion engine 157. In this embodiment, market data (which may include current and historic market pricing of various goods and services) from one or more market data feeds 162 may be fed into the conversion engine 157. In addition (or alternatively), data from users' (e.g., entities) enterprise resource planning (ERP) systems may optionally be provided via ERP feeds into a catalogue feed handler 158, and then into the conversion engine 157. Notably, the ERP feeds 159 may optionally include a two way communication feed to update ERP systems once capacity is traded to effect changes to their internal systems.

Data received into the conversion engine 157 may be validated (e.g., for completeness and accuracy) and then converted (from currency values, for example) into UTU's. To accomplish this, the conversion engine 157 executes a conversion algorithm. As an option, the conversion engine 157 may utilize data and information from the valuation engine 110b. Once converted into UTU's, the capacity data is provided to the catalog engine 160f.

Once a user identifies an order of interest (i.e., an order for which the user wants to transact) in the order catalogue 160a, the user may access and utilize a virtual data room 160b to conduct due diligence, for example, to validate and evaluate a potential transaction involving that order of interest.

Optionally, potential transactions may be generated via the matching engine 160g. To do this, the matching engine 160g may utilize data and information from the catalogue engine 160f to ‘match’ capacity with bids and/or offers.

Once users (e.g., a trader and a counterparty) have agreed to procure or sell capacity in return or for UTU's, the capacity exchange server 160 may facilitate confirmation and execution of a transaction between said users. Data relating to this transaction may then be fed to the settlement client 160h which, in conjunction with the settlement server 110c, may be configured to settle the transaction. The transaction may also be provided to an optional UTU tracker engine 160e which, as noted above, may be utilized by the currency server 110a for currency valuations.

The exchange sub-system 151 may also include one or more database servers 154 to capture data from and provide data to the exchange capacity server 160. This data may be stored on one or more databases 155 which may be accessed by back office client computer(s) 156 that serve to validate the data.

Optionally, the exemplary system 100 of FIG. 1 may also include a customer relationship management (CRM) component (not shown) embodied in either of the two sub-systems 101, 151 to provide access for servicing user clients and for tracking and organizing contact information related to prospective user clients, for example.

Although the present disclosure is not limited to the exemplary system 100 of FIG. 1, certain features and advantages of the present disclosure may be evident by examining the exemplary system 100. Such features and advantages may include (without limitation):

1. electronic discovery of capacity (e.g., product inventories, assets, services, etc.) and counterparties, which may provide for improved price discovery and a reduction in transaction costs;

2. provision of a full suite of services (including through third parties) to enhance access to insurance services, escrow services, logistical services and credit services offered by major financial organizations;

3. provision of a viable and reliable unit of account (i.e., the UTU) that may be utilized to procure products and/or services; this unit of account may be backed (at least in part) by the products and/or services of credit worthy and reliable entities committed to transact over a capacity exchange in accordance with the present disclosure;

4. ensuring liquidity by maximizing the overlap between the procurement requirements of entities and their available product/service capacity;

5. development of uniform standards for valuation of products and services (in terms of UTU's) to facilitate trade discovery and automated order matching;

6. obviate duality (which requires each party of a transaction to desire the other party's particular products and/or services), by providing a new market place based on UTU's;

7. rules and regulations for a UTU system and/or a capacity exchange system according to the present disclosure may be promulgated and implemented by a management/risk entity in conjunction with member entities. This can lead to a self-regulated market place having standardized procedures and documentation, thereby reducing legal risks and disputes and their associated costs;

8. enable entities to transact directly with each other (e.g., without having to utilize intermediary agent entities);

9. and others.

The value of a trade (e.g., capacity exchanged for products and/or services) to a corporation (or any other entity) may depend on differences between marginal costs of production and their associated elasticity of demand. Different industries and different companies within industries will have different marginal costs at different times. The examples below will show that the exchange of value can produce value from industries that produce goods that can be easily sold for full cash value.

Extractive and raw materials producers generally have no difference between fixed costs and marginal costs. In other words, they have no excess capacity. This may be illustrated, for example, by considering an oil-producing company. Generally, there is a large capital investment required in order to produce oil as a finished product. Because of this large capital investment (as well as time lags incurred to make new oil capacity available), an oil company will generally produce at full capacity all the time and sell its output for cash on the cash market. As a result, even if oil prices increase, the oil company cannot produce more oil to increase its profits. Similarly, if oil prices drop, the oil company cannot produce less oil to protect profits.

On the other hand, manufacturers generally have some degree of excess capacity and the ability to expand production or services to lower marginal costs, thereby lowering average costs. Often times, manufacturers prefer having excess capacity to be able to meet fluctuations in demand. Indeed, delaying delivery during a peak period due to lack of capacity, for example, could easily result in lost customers.

Other sectors have almost limitless available capacity. Such sectors include, for example, media, airlines, and hotels, all of which have marginal costs of production that are very low. An empty airline seat or media time slot, for example, is virtually worthless if unsold. As such, an airline or media company would be happy to fill an empty seat or time slot as long as it covered the (relatively low) administrative costs. However, selling at a price that is too low could disrupt future pricing.

From the foregoing examples, it will be evident that the value of a unit of oil differs from the value of a unit of manufacturing, which differs from the value of a unit of media. As a result, the present disclosure provides a new universal trading unit (i.e., the UTU) that serves as a universal medium for the storage and exchange of value (e.g., products and/or services) across different sectors (e.g., oil, manufacturing, media, etc.). As noted above, the UTU is a unit of account issued by an issuing entity (e.g., UTU system) that may be utilized to procure and dispose of capacity (e.g., products and/or services) via an electronic exchange system according to the present disclosure. Such an exchange system provides access to an electronic marketplace for global non-monetary trade that enables easy and efficient counterparty discovery and communications, and transaction negotiation, execution, confirmation and settlement.

In one embodiment, the UTU may be obtained by earning them through the sale of products and/or services over a capacity exchange. Alternatively, user entities may borrow UTU's from an issuing entity. This issuing entity may comprise one or more credit-worthy member entities that collectively issue, back and govern the valuation, issuance and risk management of UTU's. Liquidity and the value of UTU's may be protected, for example, by committing corporate credit to back the UTU issuances, providing high standards of governance and risk management (e.g., through participation in a risk management committee), maintaining a threshold volume of products and services available for purchase or sale on the capacity exchange. Trust and confidence in the UTU as a vehicle of exchange and unit of account may enhance the viability, utility and effectiveness of a capacity exchange system as described herein. Indeed, trades are typically not conducted in isolation. As a result, entities that may benefit from exchanging capacity may have a vested interest in the trustworthiness of the UTU. As more and more entities cooperate to back UTU's, the more trust and confidence such entities will have in the UTU. Implementation and enforcement of rules and regulations (relating the UTU's and/or the capacity exchange) may also help create trust and perpetuate the continued benefits of the efficient, trustworthy capacity market.

As indicated above, UTU's may be issued to entities that do not have actual available capacity (e.g., available products and/or services) by way of a credit facility (e.g., on a promise to make capacity available and/or to repay the issued UTU's at a future date). To reduce risk of default (and further strengthen trust in UTU's), any UTU's issued on credit may be limited in quantity to coincide with a realistic delivery capacity of a receiving entity, which may be based on past performance and/or any other capacity indicators.

UTU's may be issued on credit by way of a credit facility agreement, particular to each specific entity, which may optionally create a revolving credit facility that is to be repaid within a designated time period (e.g., 12 months), if not renewed. The credit facility agreement may further dictate repayment terms and limitations on UTU issuances. In some instances, a credit facility agreement may require a re-assessment of an entity's available or expected capacity as a condition for renewal of its credit facility agreement.

UTU's issued on credit must be repaid with UTU's that members of the exchange obtain through selling their available capacity (although under some narrowly defined circumstances it could be repaid in conventional currency). UTU's may also be issued in advance or on credit in initial amounts to initiate trading on the capacity exchange. Entities who are paid with UTU's that have been issued on credit may essentially hold a claim on the capacity (e.g., products and/or services) of the paying entity. Thus, the claim on capacity serves to economically back the UTU's.

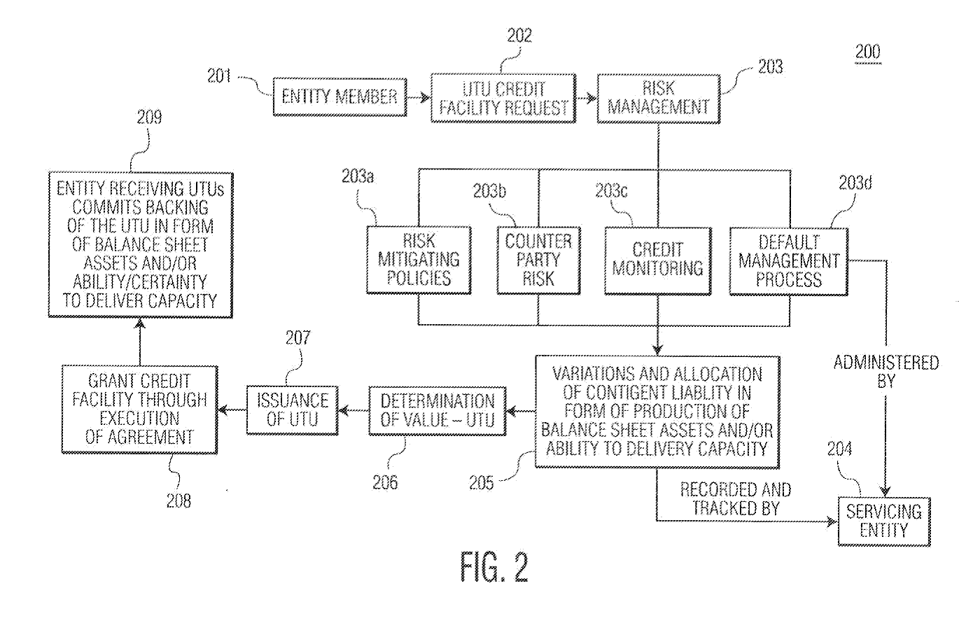

Turning now to FIG. 2, an exemplary flow diagram 200 illustrating the issuance of UTU's to a member entity via a credit facility agreement is shown. A member entity 201 with no (or limited) available capacity may initiate a UTU credit facility request 202 to obtain UTU's on credit. This request 202 may be evaluated by a risk management entity 203 (e.g., manually or electronically via computing devices configured with risk management parameters) based on any number of criteria, including (without limitation) risk mitigating policies 203a, counterparty risk 203b, credit monitoring 203c, availability of a default management processes 203d (which may optionally be administered by a UTU servicing entity 204), and any other criteria.

Next, variations and allocation of contingent liability of the entity 201 (e.g., in the form of production of balance sheet assets and/or ability to deliver capacity) may be determined 205 and recorded and tracked by the UTU servicing entity 204.

Once it is determined that UTU's will be awarded to the entity 201, the valuation of UTU's (in terms of the entity's capacity) may be determined 206, followed by issuance 207 of UTU's according to an executed credit facility agreement 208. The entity 201 receiving the UTU's may then commit to back the UTU's in the form of balance sheet assets and/or an ability/certainty to deliver capacity 209.

The value of a UTU may be dependent on the economic backing of member entities who make their products and/or services available for sale against UTU's and/or exchange capacity on a capacity exchange system. At start-up, initial UTU values may be estimated (and backed by corporate credit or other security, for example). However, over time, UTU values may be determined by parties of a trade transaction. In other words, parties to a transaction may establish a price in UTU's for a particular product or service believed to represent a fair value. Since for each individual entity UTU's ultimately represent a means of purchasing derived from its own capacity, this valuation exercise made for each individual transaction could take into account the differential between the transacting party's respective marginal product pricing or equivalently, the marginal cost of production. The valuation could also take into account each party's level of compromise. For example, one party may be willing to discount a profit margin in exchange for an enhanced utilization ratio of capacity, and the other may be willing to transfer some capacity from the cash market into the UTU where for the same utilization rate, a premium profit margin is obtained.

From the foregoing, the value of a UTU may appear to “float” (i.e., fluctuate) in respect of actual currencies. However, over time, the variation in the float may continue to diminish. As a result, a conversion of UTU-to-currency may be approximated by comparing the number of UTU's required to purchase capacity listed on a capacity exchange with the currency value of similar items in conventional cash markets. As the volume of capacity transactions increases, a comparison of the value of the UTU with conventional currencies (the “exchange rate”) will become relatively easy to calculate, and the UTU flow will become less volatile.

As indicated above, the initial value of a UTU may be estimated to initiate trading on a capacity exchange and/or issuance of UTU's to entities desiring to trade. Then, over time, the value of a UTU may ‘mature’ or evolve based on a volume of actual transactions. This evolved value may depend on many factors, such as supply and demand, and may be regulated by the balance of cash currency in circulation in relation to the products and services in the cash market.

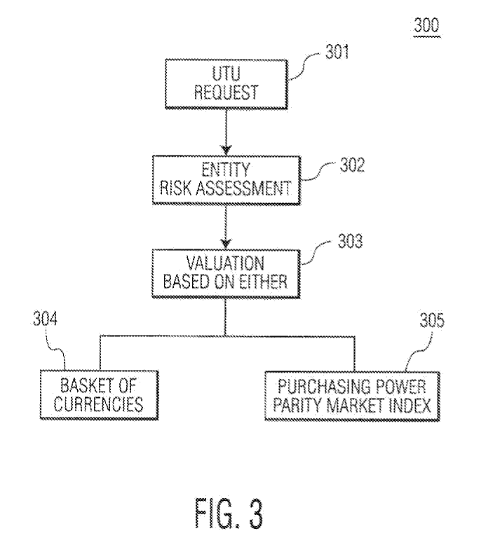

Turning now to FIG. 3, a flow diagram 300 illustrating exemplary approaches for valuing a UTU are shown. Once an entity requests UTU's (whether on credit or based on actual available capacity) 301, risks associated with that entity may be assessed 302. If it is determined that UTU's will be provided to the requesting entity, a quantity of UTU's (to be provided) may be determined based on the value (in terms of UTU's) of the entity's actual or expected capacity. This valuation 303 may be determined via a “basket of currencies” formulation 304 and/or a purchasing power parity (“PPP”) index formulation 305, both of which are described in detail below.

In one embodiment, an initial or “par” value of a UTU may optionally be estimated based on a “basket of currencies” formula (described below) which may be assigned as the UTU's initial “yardstick.” As the true value of the UTU begins to evolve, this value may be measured and tracked by a plurality of cross-rates, which enables the creation of an index. The par and true values are complementary values insofar as together, UTU trading may be initiated and maintained. Indeed, as noted above, the par value initiates issuance of UTU's and trading, and the true value, within the context of an active trading regimen within a capacity exchange system, may be utilized to determine, manage and stabilize the purchasing power of the UTU.

The above methodology establishes one exemplary approach for valuing the UTU, both initially and over time. This approach provides an indication as to a starting UTU valuation, which provides an initial point of reference or benchmark to help set prices in UTU's. The initial or ‘par’ UTU values may also be utilized to determine a price to charge those entities that have not repaid borrowed UTU's until a true UTU value is established, at which time an index of UTU purchasing power (based on the true value) may be used to price outstanding UTU's. For example, an average of the index value over a predetermined period of time may be utilized to determine the UTU price.

In one embodiment, UTU's may be loaned or issued to entities based on their available capacity and/or on their creditworthiness, in amounts that match what the entities are expected to earn by the sale of products and/or services over the capacity exchange. An exchange capacity system according to the present invention may implement and execute instructions that regulate and determine how an entities' products and services are assessed, both present and future values, to determine the amount of products and/or services that would be capable of entering the capacity exchange system for transaction activity, and this may be used to determine a credit facility amount. In this manner, the amount of UTU's in circulation on the capacity exchange system may be kept in balance with the volume of products and services available for trading, thereby avoiding possible UTU inflation.

As indicated above, the initial UTU value may be determined according to a “basket of currencies” formulation. This exemplary formulation may be based on weighted currency values of one or more world currencies. In this example, the US dollar (USD), Euro (EUR), Japanese Yen (JPY), the Sterling (GBP) and the China's Renminbi (CNY) comprise the basket of currencies, although other currencies and/or other combinations of currencies may be utilized.

The five currencies in this example are those representing the top five economic zones, each having their own currency and nominal gross domestic product (GDP) ranking. As of 2012, the nominal GDP ranking, according to the World Bank, was as follows: 1:US, 2:Euro-zone, 3:China, 4:Japan, 7:UK. Notably, numbers 5 and 6 represent Germany and France, respectively, which are not counted as part of this example because they belong to the Euro-zone.

The nominal GDP's of the selected economic zones in this example are summarized in Table 1 below. Also included in Table 1 is the ratio of nominal GDP for each zone to the combined total nominal GDP of all selected zones. As further discussed below, these ratios will be used as weightings for valuing the UTU.

TABLE 1

| | Economic | | Ratio to Total | Est. Percentage of |
|---|---|---|---|---|
| | Zone | Nominal GDP | GDP (of all zones) | Total GDP (%) |
| 1. | USA | 15,684,800 | 0.352 | 35% |
| 2. | Euro Zone | 12,200,337 | 0.274 | 27% |
| 3. | China | 8,227,103 | 0.185 | 19% |
| 4. | Japan | 5,959,718 | 0.134 | 13% |
| 5. | UK | 2,435,174 | 0.055 | 6% |
| | Total | 44,507,132 | 1.000 | 100% |

The calculated ratio's may then be utilized as weightings, as shown in Formula 1 below:

1UTU=0.35 USD+0.27 EUR+0.19 CNY+0.13 JPY+0.06 GBP 1:

To determine the monetary value of one UTU in terms of any one currency, exchange rates for each zone may be inserted into Formula 1 above. Thus, for example, to determine the value of a UTU in terms of US dollars, a current exchange rate for each zone may be substituted into Formula 1, as follows:

1UTU=0.35(1.00)+0.27(0.74)+0.19(6.13)+0.13(97.50)+0.06(0.62)=$14.43 USD.

Notably, these exchange rates may be obtained from any known or reliable source. Thus, in the example above, the monetary value of 1 UTU may be estimated at $14.43 USD. A similar process may be utilized to determine the value of a UTU in another currency.

As noted above, the calculated monetary value of a UTU may be utilized as an initial UTU value. As the markets evolve and trading progresses, the value of the UTU may evolve to reflect perceived values of users engaging in trades for UTU's. In other words, users of a capacity exchange system, by virtue of submitting bids, offers and executing trades, may establish a value for UTU's that reflects the users' perception of market value (in UTU's) of their products and/or services. This perceived valuation may be based, for example, on users' marginal costs.

Once an initial trade (for UTU's) is undertaken, the next trade may relate in some way to the initial UTU value, particularly since the initial UTU value may be based on currency, and thus reflective of current market value. Over time, the UTU values may adjust, for example, to reflect desirability (or undesirability) of certain capacity, to reflect a commission that is applicable to transactions, to reflect a desirability of users to move capacity quickly, and so on. These different (e.g., adjusted) UTU values may then be utilized (at any time and/or on a period basis) to determine a purchasing power of a UTU.

Initially, asking and offer prices for capacity (in terms of UTU's) may be based on (cash) market prices modified, for example, in order to ensure marketability by a varying margin appropriate to each line of products and/or services. This varying margin may be reflected as a discount, for example, for capacity that includes perishable products, products that are expensive to store, excess capacity, etc. In other instances, the varying margin may be reflected as a premium, such as in connection with airline tickets where capacity has low marginal costs and cash is scarce. In this example, airline companies may be willing to pay a premium compared for jet fuel if they could ‘purchase’ the fuel with UTUs, and so conserve their scarce cash. Once a capacity exchange is operating, the new issues of UTU's may be valued based on purchasing power (rather than on a ‘basket-of-currencies’ valuation methodology).

The discount and/or premium reflected in UTU pricing may be hidden. For example, even if a low-margin producer does not appear to be receiving a premium price on their products and/or services, the purchasing power of acquired UTU's may be enhanced by the high availability of discounted prices. Similarly, even if high-margin producers do not appear to be providing a discount, the discount may be reflected if such producers acquire products and/or services at premium prices.

It should be noted that transactions for similar products and/or services at similar times may take place at different UTU prices, reflecting different margins. Also, transactions between the same parties at different times may take place at different prices, although over time, competition and trade volume may tend to bring prices fairly close to one another. Ultimately, the value of the UTU may converge to a purchasing power parity (or “PPP”) value. As a result, an identical product (offered on a capacity exchange according to this disclosure) may have similar to identical pricing regardless of the offeror (e.g., the source of the capacity).

Capacity transactions (for UTU's) on a capacity exchange according to this disclosure may offer gains to both sides of such transactions, particularly if the capacity being sold would not have been sold at all, or in the case of premiums, that would have sold for a lesser margin in the cash market. Since some gain is better than nothing, users may be willing to dispose of capacity at low UTU prices, which may affect the purchasing power of the UTU.

In one embodiment, an index may be constructed and utilized to measure the purchasing power of the UTU, that is, the set of goods or services that a UTU can command. In other words, an index may be used to measure the command of the UTU over the products and/or services (e.g., on a capacity exchange) relative to the command of other currencies over the same products and/or services on the open market (outside of a capacity exchange). Such an index may prove useful in a number of ways, such as in the case of a user's inability to repay borrowed UTU's, or in the case of withdrawal. It might also be used in connection with issuing of new loans (for UTU's) or rollovers.

In one embodiment, an index may be created by identifying a quantity of products and/or services exchanged on a capacity exchange over a particular period of time (which may be arbitrary, or optionally long enough to allow for all users to trade), and then multiplying each such quantity by its UTU price. Next, the same set of quantities may be multiplied by their respective prices in terms of actual currency (e.g., in the cash market) and compared to the UTU price results. Dividing one expression into the other gives the ratio of the purchasing power of the UTU to currency.

Optionally, the availability of capacity in each market (i.e., UTU vs. cash) may be considered in determining the purchasing power of the UTU as compared to the purchasing power of currency. To do this, rather than using the same set of quantities in both markets (i.e., UTU vs. cash) as outlined above), the quantity of products and/or services exchanged available (or sold) in the cash market may be used to compare currency prices multiplied by said products and/or services to UTU prices multiplied by quantity of products and/or services exchanged (or available) on a capacity exchange.

As noted above, the relative value of a UTU may vary over time. As a result, the purchasing power value of a UTU may also vary from time to time, from trade to trade or from company to company until a steady-state or ‘equilibrium’ state is reached.

Optionally, the UTU does not need to be tied to any monetary currency at all. In this manner, the value of a UTU may avoid speculation.

In one narrowly defined exemplary embodiment, borrowed UTU's may be repaid using conventional currency. To determine the amount of conventional currency owed, a UTU index may be constructed that reflects the capacity (e.g., products and/or services) being exchanged on a capacity exchange. To do this, a cash value for a UTU may be determined by identifying the cash prices of the capacity actually being traded on a capacity exchange, weighting such prices according to the quantities on such an exchange, and treating the result as the cash value of a UTU for repayment purposes. As noted above, the quantity of issued UTU's is optionally kept in line with the amount of products and/or services available for exchange, a feature that is counter-inflationary. That said, UTU ‘credit’ (i.e., UTU's issued in advance of providing actual capacity) may optionally be advanced to creditworthy entities, as noted above. To maintain integrity, repayment of the UTU's may be requested within a relatively short time period (e.g., 12 months). Issues of UTU credit may be aligned with an entity's ability to earn UTU's from sales, for example. Thus, the repayment requirement ensures that UTU's will be used and earned, thus resulting in the circulation of UTU's on the capacity exchange of the present disclosure. Those obtaining UTU's via credit may be motivated to obtain value for them as quickly as possible, causing a high velocity of UTU turnover in the capacity exchange.

The foregoing concept may be illustrated through the use of an illustrative example. In this example, it is assumed that a company has excess capacity which it would like to mobilize and create value from, and also that the company needs certain products which it does not currently have the funds to purchase. This hypothetical company wishes to become a member of a capacity exchange as described herein in order to sell its capacity, thereby creating new working capital in the form of UTU's which it may use to acquire the products it needs. The company may obtain UTU credits either by qualifying as a creditworthy (e.g., investment grade credit) entity, in which case the company may receive a UTU loan, or, alternatively, the company could become a member of the capacity exchange and earn UTU's by offering and/or ‘selling’ its capacity on the capacity exchange.

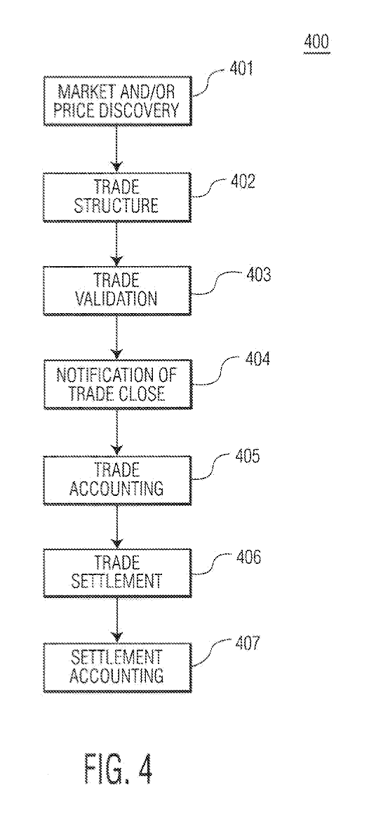

Turning now to FIG. 4, a block diagram illustrating an exemplary life cycle 400 of a capacity transaction in accordance with the present disclosure. The exemplary life cycle 400 may commence with market and/or price discovery 401. Market discovery may include searching for available capacity, trading opportunities and/or counterparties using a capacity exchange system according to the present disclosure. Searching for capacity and/or trading opportunities (e.g., bids and/or offers) may be accomplished by searching an order catalogue (manually or automatically), for example, within the capacity exchange system. Counterparty discovery may be achieved, for example, via an optional matching engine within the capacity exchange system; although manual and/or automatic counterparty searching may also be used for counterparty discovery. Market discovery may also be achieved by interfacing with inventory management and/or procurement management systems (e.g., ERP's) of other entities. Similar methods and systems may be utilized for price discovery.

Once market and/or price discovery 401 has been completed, a next step may include trade-structuring 402, which may include identifying, proposing and/or accepting a potential capacity transaction between a party and a counterparty. Structured trades may then be validated 403 to confirm the terms, price, delivery, quantity, and other transaction details. Once validated 403, a capacity transaction may be executed (via a capacity exchange system, for example) and a notification of trade close 404 may be provided (e.g., transmitted) to the party and counterparty (e.g., to their respective bookkeeping systems), and recorded in the capacity exchange system on with the transaction was executed. The trade close 404 information and other transaction details may then be used for trade accounting 405 purposes.

At the scheduled delivery/settlement time, one party delivers (or provides) the object of the transaction (e.g., product and/or service capacity) to the counterparty, thereby perfecting trade settlement 406. Once settled, details of the settlement may be utilized for settlement accounting 407.

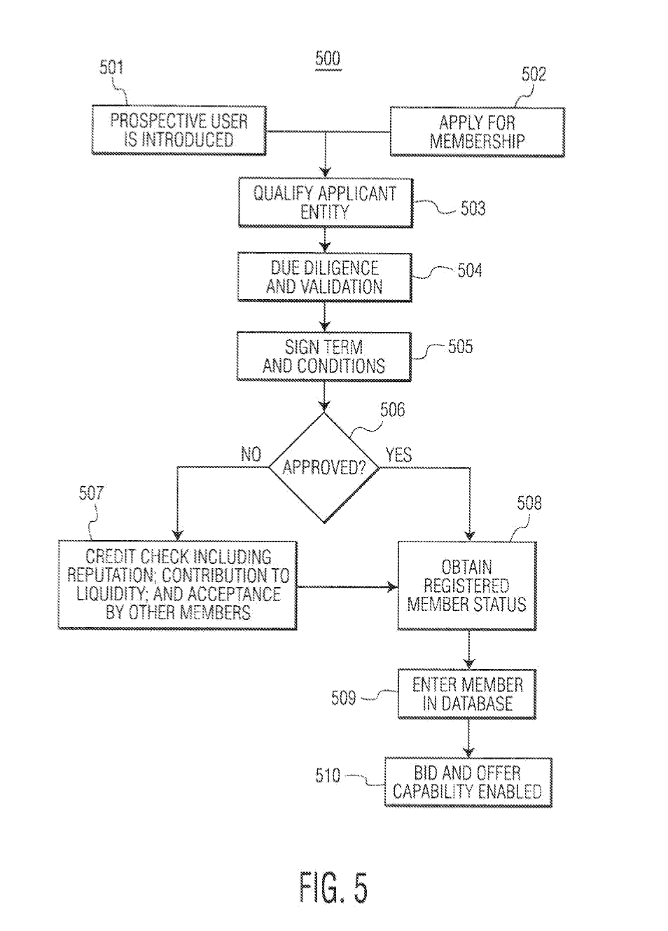

FIG. 5 shows a flow diagram illustrating an exemplary method 500 of qualifying an entity 501 for membership to a capacity exchange in accordance with the present disclosure. An entity 501 desiring to utilize and/or join a capacity exchange as a member may first apply for membership 502. Applying for membership 502 may include submitting and/or providing data and information via a computing device to another computing device. Such data and information may then be processed and if certain predetermined parameters are satisfied, the entity 501 may be initially qualified 503 for use and/or membership. Part of this qualification process may also include conducting due diligence and validation 504 of the entity data and information. This may occur electronically and/or manually.

Next, the prospective entity 501 may optionally be required to sign terms and conditions 505 for use and/or membership to the capacity exchange, and if the entity 501 is approved 506, the entity 501 may be granted registered member status 508. If, however, the entity 501 is not approved, additional qualification inquiries 507 may be utilized to approve the entity 501. These additional inquiries may include (without limitation) checking the entity's credit rating, checking the entity's reputation, determining the entity's ability to contribute liquidity to the capacity exchange, input from existing member entities, etc. Once approved, the entity 501 may be entered as a member into the capacity exchange database 509 and the entity's 501 use privileges (e.g. enter bids and offers, initiate and except transactions, market and price discovery, etc.) 510.

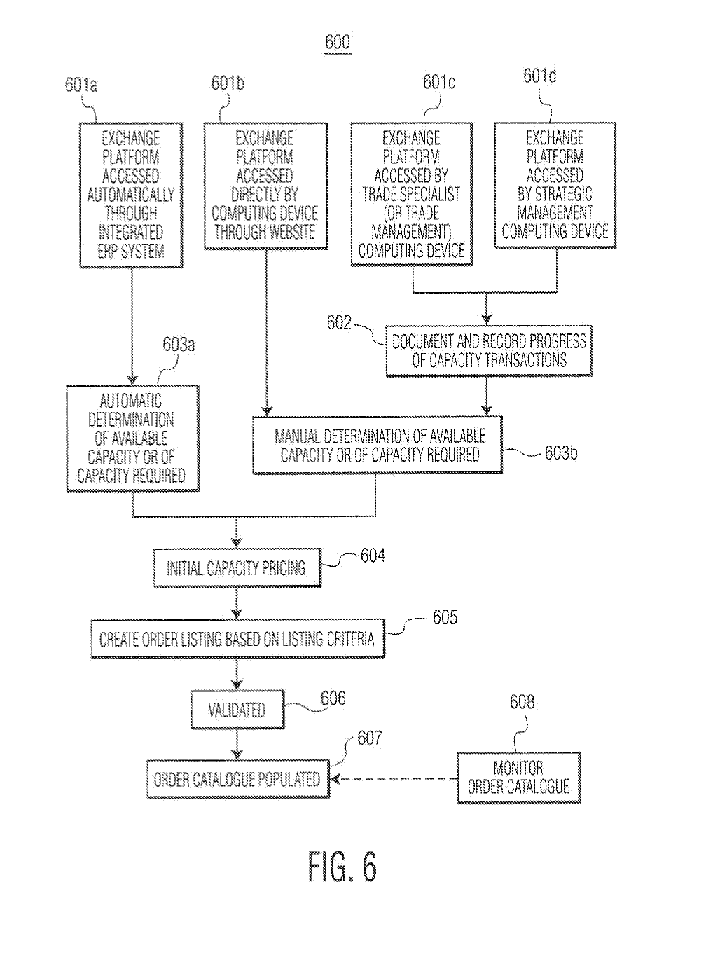

Turning now to FIG. 6, an exemplary method 600 by which capacity orders (e.g. bids and offers) may be entered into an order catalogue within a capacity exchange system in accordance with the present disclosure is shown. As an initial step, the capacity exchange system (e.g., the exchange platform within the capacity exchange system) may be accessed automatically via an entity's enterprise resource planning (ERP) systems 601a or directly via a member entity's computing device via, for example, a website 601b. Other entities, such as trade specialists and/or strategic management entities (or any other entity) may also access the capacity exchange via trade specialist computing devices 601c and/or strategic management computing devices 601d. Optionally, progress of any capacity transactions may be documented and recorded at step 602.

Once the capacity exchange is accessed, the available and/or needed capacity of a particular entity may be determined automatically 603a and/or manually 603b. Next, an initial pricing (e.g., in terms of UTU's) for the determined capacity may be determined 604, and an order listing (including the capacity and price) may be created 605 according to predetermined order listing criteria. Once the order listing is created 605, it may be validated 606 and entered into an order catalogue 607 within the capacity exchange as a bid and/or offer. Optionally, the order catalogue (and any bids and orders listed therein) may be monitored 608, for example, for continued compliance with predetermined criteria.

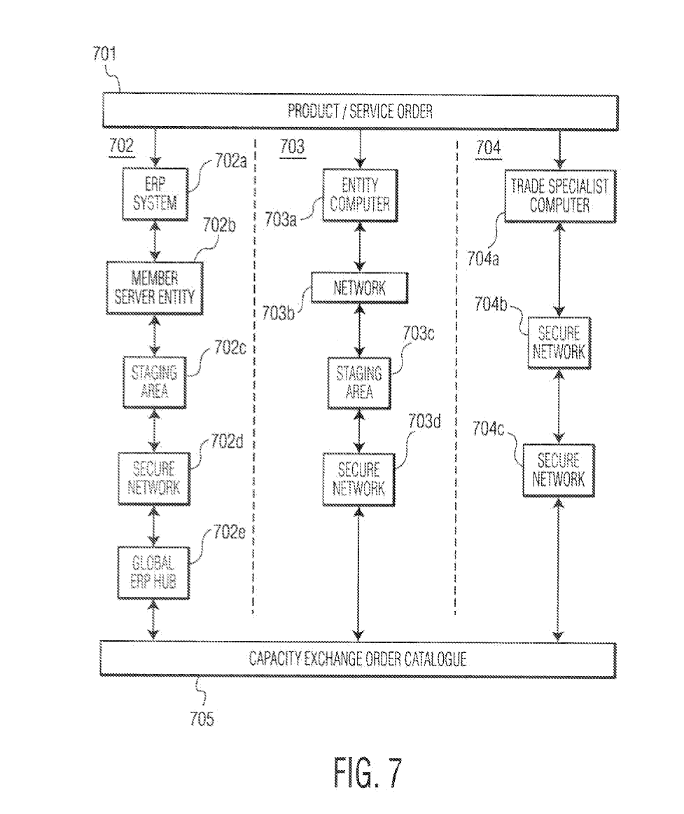

FIG. 7 shows certain exemplary (non-limiting) system components of a capacity exchange that may be configured for entering and receiving capacity orders in accordance with the present disclosure. Once a capacity order (e.g., a product and/or service order) 701 that complies with listing and matching parameters of the capacity exchange is created, a member entity's ERP system 702a may automatically access and submit the capacity order to an order catalogue embodied on the capacity exchange 705. To accomplish this, the member entity's ERP system 702a may be coupled to a member entity server 702b having a staging area 702c for holding the capacity order, which may then be transmitted over a secure (wired or wireless) network 702d to an ERP hub 702e coupled to the capacity exchange 705.

Alternatively, a member entity may submit the capacity order 701 via a member computing device 703a that transmits the capacity order via a wired or wireless network 703b (e.g., the Internet) to a staging area component 703c for holding the capacity order, which may then be transmitted over a secure (wired or wireless) network 703d to the capacity exchange 705.

Trade specialists and other entities may submit the capacity order 701 via a computing device 704a that transmits the capacity order over a first secure (wired or wireless) network 704b to a second secure (wired or wireless) network 704c, and then to the capacity exchange 705.

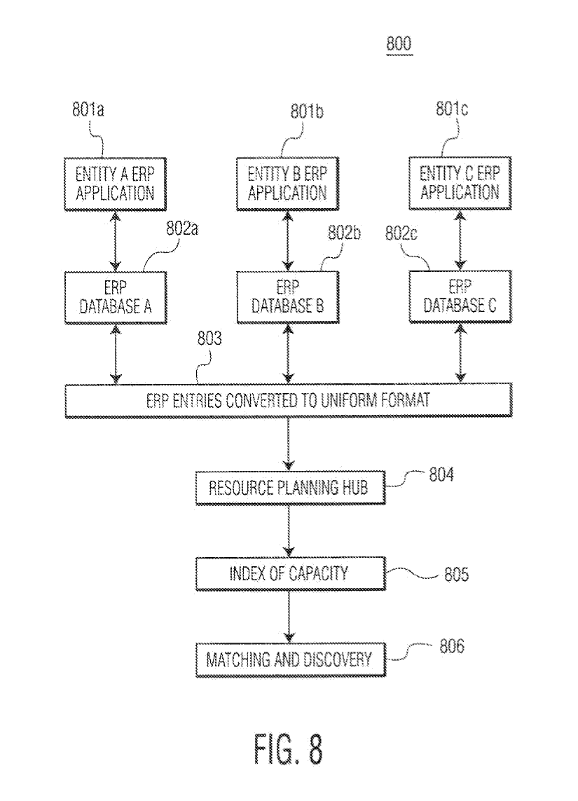

FIG. 8 illustrates an exemplary data flow 800 between member entity ERP systems and a resource planning hub in accordance with the present disclosure. Entity ERP application software 801a, 801b, 801c executing on respective computing devices (not shown) may be configured to identify entity capacity and/or procurement requirements to generate ERP entries that may be stored and maintained in respective ERP databases 802a, 802b, 802c. The ERP entries may then be provided to a resource planning application 803 embodied in a resource planning hub module 804 where the ERP entries may be converted into a uniform format, each comprising a standardized identifier (e.g., capacity entry identification). The resource planning hub module 804 may further be configured to create an index of the ERP entries (e.g., according to capacity entry identification) such that the ERP entries may be searched, matched and available for discovery.

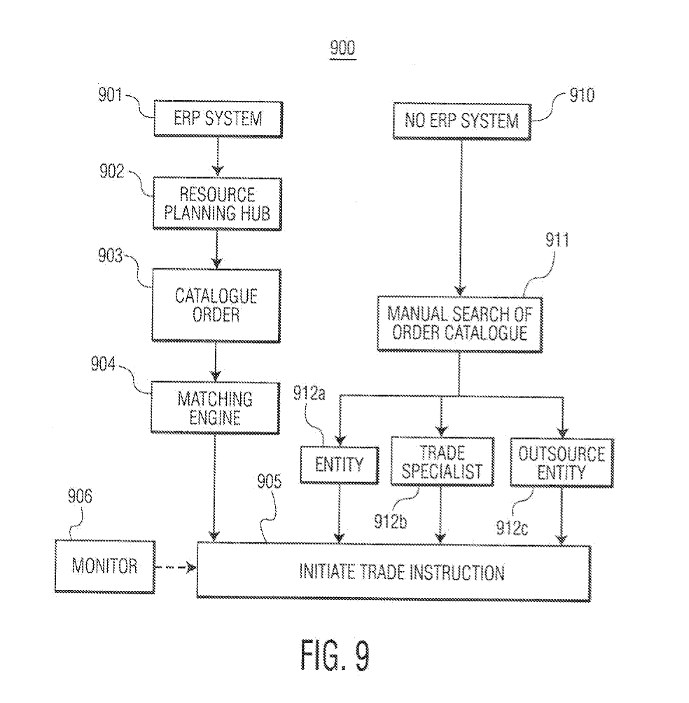

Turning now to FIG. 9, a flow diagram illustrating exemplary methods and systems for searching and matching capacity orders to initiate capacity transactions in accordance with the present disclosure is shown. Capacity entries from entity ERP systems 901 may be provided to a resource planning hub module 902 embodied in a capacity exchange system. The resource planning hub module 902 may convert the capacity entries into capacity orders to populate an order catalogue module 903. A matching engine 904 embodied in the capacity exchange system may then match capacity orders with other capacity orders in the catalogue module 903. Once orders are matched, instructions for initiating a capacity transaction (e.g., via a capacity transaction module) may then be generated.

Alternatively, entities that do not include an ERP system 910 may manually search an order catalogue via one or more computing devices, including (without limitation) entity computing devices 912a, trade specialist computing devices 912b, outsource entity computing devices 912c, or any other type of computing device(s). These entity computer devices 912a, 912b, 912c may then be utilized to generate instructions for initiating a capacity transaction 905. Optionally, a monitoring computing device 906 may monitor transaction instructions and transactions.

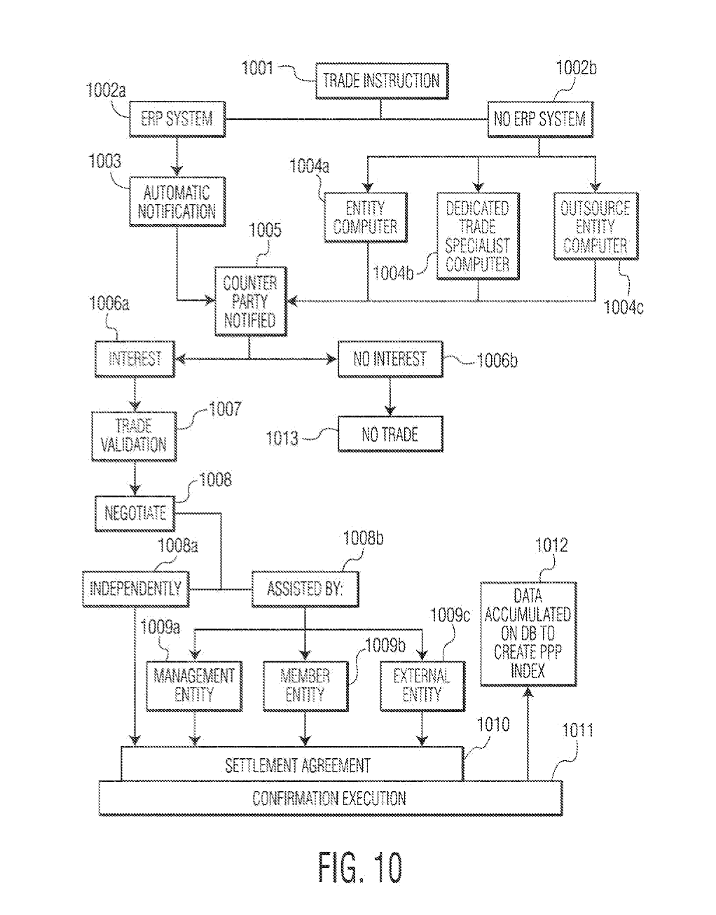

FIG. 10 includes a flow diagram illustrating an exemplary systems and methods of consummating capacity transactions in accordance with the present disclosure. Transaction instructions 1001 may be received and/or identified by a transaction execution module (embodied in a capacity exchange system, for example) automatically 1003 via an entity ERP system 1002a or, if an entity does not include an ERP system 1002b, manually via one or more entity computing devices (e.g., entity computer 1004a, trade specialist computer 1004b, outsource entity computer 1004c, or any other entity computer (not shown)).

Next, a potential counterparty may be notified 1005 electronically of a possible capacity transaction, for example, via a counterparty computing device (not shown). If the counterparty is not interested in a capacity transaction 1006b, the process stops and no transaction is consummated 1008.

If, however, the counterparty is interested in engaging in a capacity transaction 1006a, the potential transaction may be validated 1007 (via a validation module) and the counterparty and initiator of the transaction instruction 1001 may negotiate terms of the capacity transaction 1008 via, for example, their respective computing devices. These negotiations 1008 may be conducted independently 1008a (e.g., directly between the party initiating the transaction instruction and counterparty) or assisted 1008b by a management entity 1009a associated with the capacity exchange system, a member entity 1009b of the capacity exchange system, or any other entity 1009c that is external to the capacity exchange system.

Once negotiations are completed, a settlement agreement may be consummated 1010, and a capacity transaction may be confirmed and executed 1011 according to the terms of the settlement agreement. Such terms may include, for example, transaction financing, escrow, warehousing, payments, insurance, etc.

Once the capacity transaction is completed, data relating to the capacity transaction may optionally be recorded in a database 1012 for later use to track and determine capacity pricing (e.g., to create UTU purchasing power index).

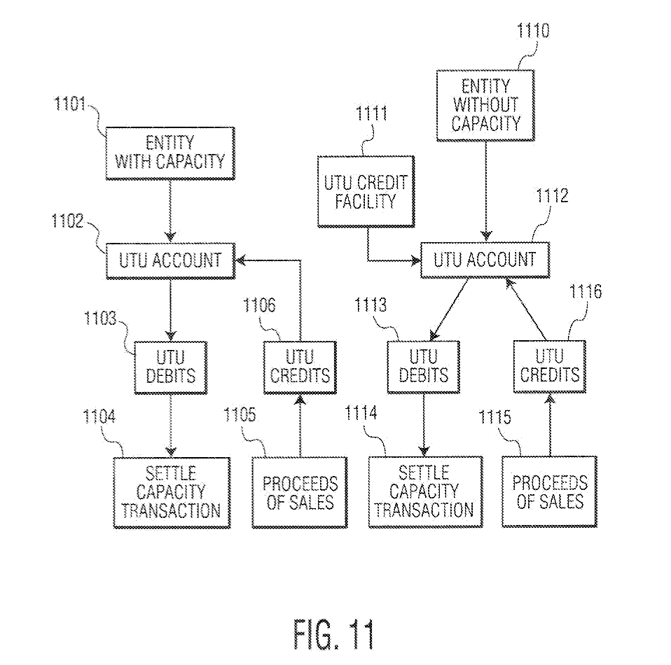

FIG. 11 includes an exemplary flow diagram that illustrates methods of accounting a non-monetary unit of exchange in accordance with the present disclosure. An entity 1101 having actual capacity may create a UTU account 1102 that includes a quantity of UTU's representative of the entity's actual capacity. Upon engaging in a capacity transaction to procure capacity from another entity (e.g., via a capacity exchange system), UTU's may be debited 1103 from the entity's account 1102 to settle the capacity transaction 1104. Alternatively, if the entity 1101 ‘sells’ its capacity (e.g., a capacity exchange system), proceeds from the sale 1105 may be credited 1106 to the entity's UTU account 1102.

An entity 1110 that does not have available capacity may still create a UTU account 1112 that may be funded with a UTU credit facility 1111. In other words, the entity 1110 may receive UTU's on credit. This UTU credit facility may be rewarded, for example, if the entity 1110 qualifies based on any number of criteria (e.g., credit rating, production capacity, sales history, etc.). Once the UTU account 1112 is funded, the entity 1110 may procure capacity from other entities by engaging in capacity transactions (e.g., a capacity exchange system). UTU's may then be debited 1113 from the UTU account 1112 to settle the capacity transaction 1114. Alternatively, if the entity 1110 ‘sells’ its capacity (e.g., a capacity exchange system), proceeds from the sale 1115 may be credited 1116 to the entity's UTU account 1112.

1. A method of facilitating non-monetary capacity transactions, comprising:
receiving at an electronic capacity exchange system one or more capacity orders, said capacity orders each comprising at least one of a product and a service description and an associated order value in terms of non-monetary universal trading units (UTU's);
receiving at the electronic capacity exchange an electronic indication of interest corresponding to at least one of the capacity orders;
comparing, by said electronic capacity exchange system, certain data included in the indication of interest (“interest data”) with corresponding data included in the at least one capacity order (“order data”);
if, based on said comparison, the interest data matches the order data, executing by said electronic capacity exchange system a capacity transaction for the at least one capacity order; and
at least one of issuing and debiting a quantity of UTU's to at least one electronic UTU account to settle the executed capacity transaction.

2. The method of claim 1, wherein the one or more capacity orders includes at least one procurement order and at least one sales order, the method further comprising:
automatically matching, via a matching engine embodied in the electronic capacity exchange system, the at least one procurement order with the at least one sales order to form an executable capacity transaction if certain procurement data within the at least one procurement order matches certain capacity data within the at least one sales order.

3. The method of claim 1, further comprising:
electronically receiving at the electronic capacity exchange system data from at least one enterprise resource planning (ERP) system comprising procurement or sales capacity data and associated pricing data (“ERP data”);
validating the ERP data via a validation engine embodied in the electronic capacity exchange system, said validating comprising confirming that the ERP data complies with predetermined parameters;
converting, via a conversion engine embodied in the electronic capacity exchange system, the ERP pricing data into UTU's; and
generating at least one ERP capacity order based on the ERP data,
said ERP capacity order being configured for matching with any of the one or more capacity orders, and execution as part of a capacity transaction.

4. The method of claim 1, wherein the interest data and order data comprises listing data in a format that is standard across all capacity orders included in the electronic capacity exchange system.

5. The method of claim 1, further comprising validating the order value associated with the at least one capacity order, said validating step comprising:
determining a margin cost associated with the at least one capacity order; and
comparing the order value of the at least one capacity order, in terms of UTU's, with a cash value associated with capacity that is the subject of the at least one capacity order.

6. The method of claim 5, wherein the validating step comprises:
receiving at the electronic capacity exchange electronic market data;
retrieving, via said electronic capacity exchange system, historical order value data pertaining to previously executed capacity transactions; and
comparing the order value associated with the at least one capacity order with the received market data and the retrieved historical order value data.

7. The method of claim 1, further comprising receiving the one or more capacity orders from one or more entity computing devices via at least one of a wired and wireless network.

8. The method of claim 1, wherein the electronic indication of interest comprises a quantity of UTU's offered in exchange for the at least one of a product and service described in the at least one capacity order.

9. The method of claim 1, further comprising:
determining, via a UTU server, a quantity of UTU's to issue to an entity authorized for transacting via the electronic capacity exchange system; and
issuing said quantity of UTU's to said entity by crediting said quantity to an electronic UTU account associated with said entity, said electronic UTU account being configured for receiving UTU credits and debits from said electronic capacity exchange system.

10. The method of claim 9, wherein the quantity of issued UTU's is economically backed by at least one of balance sheet assets and a calculated ability to provide future capacity.

11. The method of claim 9, wherein determining the quantity of UTU's to issue comprises:
determining a cash value of the entity's available capacity; and
converting the cash value into the quantity of UTU's.

12. The method of claim 11, wherein converting the cash value into the quantity of UTU's comprises determining an exchange rate between UTU's and cash according to at least one of a basket-of-currency formulation and a purchasing power parity (or “PPP”) index.

13. The method of claim 9, wherein determining the quantity of UTU's to issue comprises:
determining a creditworthiness of the entity;
determining a cash value of the entity's expected future capacity;
converting the cash value into the quantity of UTU's; and
issuing the quantity of UTU's according to a credit facility.

14. The method of claim 13, further comprising:
enhancing the creditworthiness of the entity via one or more forms of economic backing, said forms comprising one or more of: performance guarantee insurance, corporate credit, a loan structure, a structured financing, a securitization, collateralization, one or more commodities, one or more asset baskets, a derivative, third party credit, bill of exchange, letter of credit, factoring, and an engineered financial product.

15. The method of claim 9, wherein each UTU in the quantity of UTU's is non-interest bearing.

16. An electronic capacity exchange system comprising:
one or more computing devices in communication with one another via at least one of a wired and wireless network, each of said computing devices comprising one or more processors and memory storing computer-readable instructions that when executed cause said one or more computing devices to:
receive one or more capacity orders, said capacity orders each comprising at least one of a product and a service description and an associated order value in terms of non-monetary universal trading units (UTU's);
receive an electronic indication of interest corresponding to at least one of the capacity orders;
compare certain data included in the indication of interest (“interest data”) with corresponding data included in the at least one capacity order (“order data”);
if, based on said comparison, the interest data matches the order data, execute a capacity transaction for the at least one capacity order, and
at least one of issue and debit a quantity of UTU's to at least one electronic UTU account to settle the executed capacity transaction.

17. The electronic capacity exchange system of claim 16, wherein the one or more capacity orders includes at least one procurement order and at least one sales order, said system further comprising computer-readable instructions that when executed cause said one or more computing devices to:
automatically match, via a matching engine embodied in the electronic capacity exchange system, the at least one procurement order with the at least one sales order to form an executable capacity transaction if certain procurement data within the at least one procurement order matches certain capacity data within the at least one sales order.

18. The electronic capacity exchange system of claim 16, further comprising computer-readable instructions that when executed further cause said one or more computing devices to:
electronically receive data from at least one enterprise resource planning (ERP) system comprising procurement or sales capacity data and associated pricing data (“ERP data”);
validate the ERP data via a validation engine embodied in the electronic capacity exchange system by confirming that the ERP data complies with predetermined parameters;
convert, via a conversion engine embodied in the electronic capacity exchange system, the ERP pricing data into UTU's; and
generate at least one ERP capacity order based on the ERP data,
said ERP capacity order being configured for matching with any of the one or more capacity orders, and execution as part of a capacity transaction.

19. The electronic capacity exchange system of claim 16, wherein the interest data and order data comprises listing data in a format that is standard across all capacity orders included in the electronic capacity exchange system.

20. The electronic capacity exchange system of claim 16, further comprising computer-readable instructions that when executed cause the one or more computing devices to validate the order value associated with the at least one capacity order by determining a margin cost associated with the at least one capacity order and comparing the order value of the at least one capacity order, in terms of UTU's, with a cash value associated with capacity that is the subject of the at least one capacity order.

21. The electronic capacity exchange system of claim 20, further comprising computer-readable instructions that when executed cause the one or more computing devices to validate the order value by:
receiving electronic market data;
retrieving historical order value data pertaining to previously executed capacity transactions; and
comparing the order value associated with the at least one capacity order with the received market data and the retrieved historical order value data.

22. The electronic capacity exchange system of claim 16, further comprising computer-readable instructions that when executed cause the one or more computing devices to receive the one or more capacity orders from one or more entity computing devices via at least one of a wired and wireless network.

23. The electronic capacity exchange system of claim 16, wherein the electronic indication of interest comprises a quantity of UTU's offered in exchange for the at least one of a product and service described in the at least one capacity order.

24. The electronic capacity exchange system of claim 16, further comprising computer-readable instructions that when executed cause the one or more computing devices to:
determine, via a UTU server, a quantity of UTU's to issue to an entity authorized for transacting via the electronic capacity exchange system; and
issue said quantity of UTU's to said entity by crediting said quantity to an electronic UTU account associated with said entity, said electronic UTU account being configured for receiving UTU credits and debits from said electronic capacity exchange system.

25. The electronic capacity exchange system of claim 24, wherein the quantity of issued UTU's is economically backed by at least one of balance sheet assets and a calculated ability to provide future capacity.

26. The electronic capacity exchange system of claim 24, further comprising computer-readable instructions that when executed cause the one or more computing devices to determine the quantity of UTU's to issue by determining a cash value of the entity's available capacity, and converting the cash value into the quantity of UTU's.

27. The electronic capacity exchange system of claim 26, further comprising computer-readable instructions that when executed cause the one or more computing devices to convert the cash value into the quantity of UTU's by determining an exchange rate between UTU's and cash according to at least one of a basket-of-currency formulation and a purchasing power parity (or “PPP”) index.

28. The electronic capacity exchange system of claim 24, further comprising computer-readable instructions that when executed cause the one or more computing devices to determine the quantity of UTU's to issue by:
determining a creditworthiness of the entity;
determining a cash value of the entity's expected future capacity;
converting the cash value into the quantity of UTU's; and
issuing the quantity of UTU's according to a credit facility.

29. The electronic capacity exchange system of claim 28, further comprising computer-readable instructions that when executed cause the one or more computing devices to:
enhance the creditworthiness of the entity via one or more forms of economic backing, said forms comprising one or more of: performance guarantee insurance, corporate credit, a loan structure, a structured financing, a securitization, collateralization, one or more commodities, one or more asset baskets, a derivative, third party credit, bill of exchange, letter of credit, factoring, and an engineered financial product.

30. The electronic capacity exchange system of claim 24, wherein each UTU in the quantity of UTU's is non-interest bearing.
